(19) United States
(12) Patent Application Publication
(10) Pub. No.: US 2012/0020078 A1
(43) Pub. Date: Jan. 26, 2012

(54) SURFACE LIGHT SOURCE DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/070,482

(22) Filed: Mar. 24, 2011

(30) Foreign Application Priority Data
Jul. 26, 2010 (CN) 201010236737.5

(51) Int. Cl. F21V 7/00; F21V 1/00

(52) U.S. Cl. 362/235

(57) ABSTRACT

A surface light source device includes a number of light sources, a first prism sheet and a second prism sheet. The light sources are distributed on a bottom plate of a housing. The first prism sheet and the second prism sheet are arranged above the light sources in that order. The light sources and the first prism sheets are spaced by a first predefined distance, and the first prism sheets and the second prism sheets are spaced by a second predefined distance. The light emitting surface of the first prism sheet includes a number of first diffusion structures, and the light emitting surface of the second prism sheet includes a number of second diffusion structures. Light beams emitted by the light sources are substantially diffused after passing through the first prism sheet and the second prism sheet and become surface light beams.

### BACKGROUND

1. Technical Field

The present disclosure relates to surface light source devices and, particularly, to a surface light source device employing double prism sheets.

2. Description of Related Art

A light-emitting diode (LED) is a point light source with a small radiation angle and strong directionality, and is now being widely used in lighting devices. A number of LEDs distributed in rows on the lighting device is usually needed to obtain a large lighting area. However, when a number of LED light sources illuminate on an object from different direction at the same time, a number of shadows of the illuminated object will be produced. Furthermore, high brightness from the LEDs cause light spots on the lighting surface of the LED lighting device. An extra light diffusion film is needed to avoid the shadows, and reduce the light spots and achieve a uniform lighting surface. However, the light diffusion film may absorb part of the light from the light-emitting diodes. Thus, the brightness of light illumination of the lighting device is reduced.

Therefore, what is needed is a surface light source device to overcome the above-mentioned shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a side cross-sectional view of a surface light source device according to an embodiment.

FIG. 2 is a schematic, isometric view of a first prism sheet of the surface light source device of FIG. 1.

### DETAILED DESCRIPTION

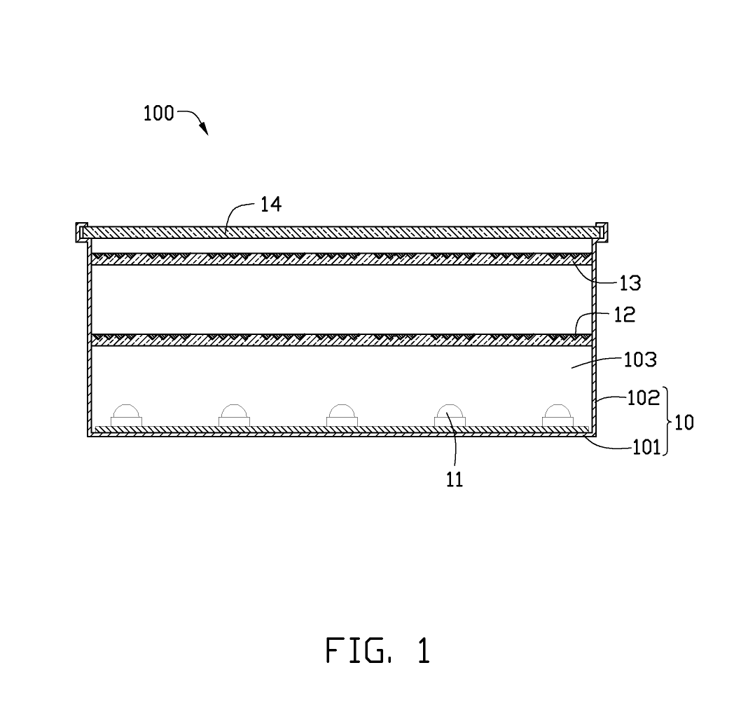

Referring to FIG. 1, a surface light source device 100 is illustrated. The surface light source device 100 includes a housing 10, a number of light sources 11, a first prism sheet 12, a second prism sheet 13, and a transparent plate 14. The housing 10 includes a bottom plate 101 and a number of sidewalls 102 extending from the periphery of the bottom plate 101, which cooperatively define a space 103. The housing 10 can reflect some of the light upwards. In the embodiment, the housing 10 is made of metal or plastic material with high reflectivity rate. In an alternative embodiment, the housing 10 may have a high reflective coating applied on its internal sidewall for improving light reflectivity rate.

The light sources 11 are distributed on the bottom plate 101. In the embodiment, the light sources 11 are a number of point light sources, such as light-emitting diodes. In an alternative embodiment, a number of linear light sources, such as cold cathode tubes, can replace the point light sources 11.

The first prism sheet 12 is arranged above the light sources 11, and the second prism sheet 13 is arranged above the first prism sheet 12. The transparent plate 14 is arranged above the second prism sheet 13 and covers the housing 10. Light beams emitted by the light sources 11 are substantially diffused after passing through the first prism sheet 12 and the second prism sheet 13, and finally become surface light beams exiting the transparent plate 14.

In the embodiment, the first prism sheet 12, the second prism sheet 13 and the transparent plate 14 are substantially parallel to the bottom plate 101. The light sources 11 and the first prism sheets 12 are approximately spaced by a first predefined distance, and the first prism sheets 12 and the second prism sheets 13 are approximately spaced by a second predefined distance.

The transparent plate 14 prevents the second prism sheet 13 from being contaminated, or scratched. In the embodiment, the transparent plate 14 can be transparent glass, frosted glass, or transparent plastic plate.

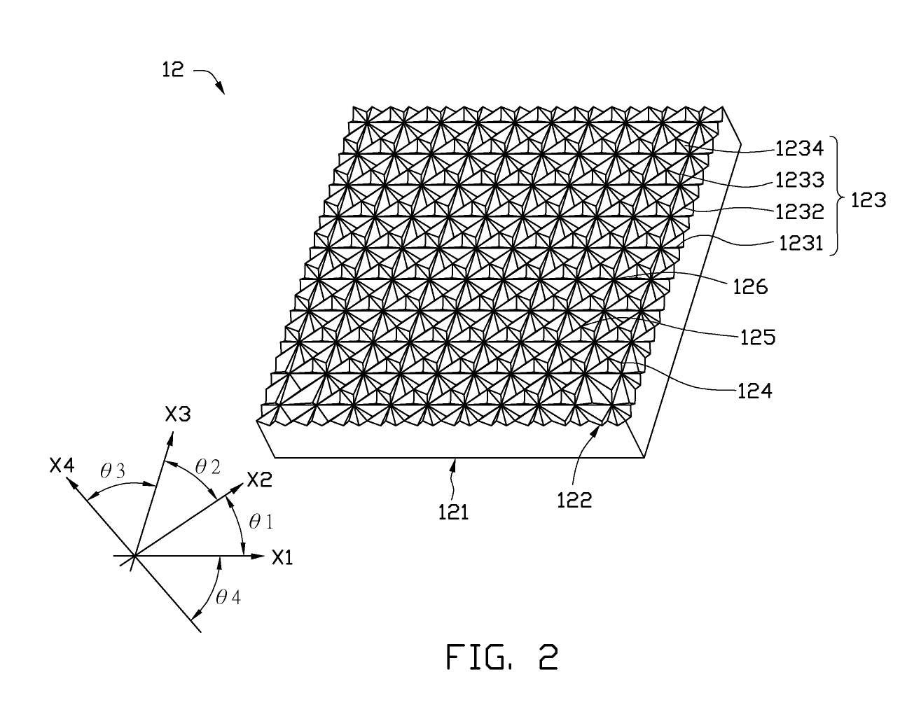

Referring to FIG. 2, the first prism sheet 12 is made of transparent plastic material, and includes a light incident surface 121 and a light emitting surface 122. The light incident surface 121 and the light emitting surface 122 are at opposite sides of the first prism sheet 12. In the embodiment, the light incident surface 121 is a planar surface, and faces the light sources 11. The light emitting surface 122 includes a number of first diffusion structures 123. In the embodiment, the first diffusion structures 123 are in the form of a number of long-strip V-shaped ridge structures extending along at least two different directions and being mutually staggered.

In the embodiment, the V-shaped ridge structures 123 extend along four different directions, and include a number of first long-strip V-shaped ridge structures 1231 extending along a first direction X1, a number of second long-strip V-shaped ridge structures 1232 extending along a second direction X2, a number of third long-strip V-shaped ridge structures 1233 extending along a third direction X3, and a number of fourth long-strip V-shaped ridge structures 1234 extending along a fourth direction X4.

In the embodiment, the first direction X1 and the second direction X2 define a first included angle θ1. The second direction X2 and the third direction X3 define a second included angle θ2. The third direction X3 and the fourth direction X4 define a third included angle θ3. The first direction X1 and the fourth direction X4 define a fourth included angle θ4. In the embodiment, each of the angles θ1, θ2, θ3 and θ4 is about 45 degrees.

Each three V-shaped ridge structures 123 extending along different directions cooperatively define a micro-dent 124. Each of the micro-dents 124 includes three side surfaces connected in order. Each four adjacent micro-dents 124 cooperatively define a first micro-protrusion 125, and each eight adjacent micro-dents 124 cooperatively define a second micro-protrusion 126. With such structure, the V-shaped ridge structures 123 can diffuse the incident light into a number of virtual light sources gathering in the vertexes of the first micro-protrusions 125 and the second micro-protrusions 126.

The structure of the second prism sheet 13 is similar to that of the first prism sheet 12, and is made of transparent plastic material. The light incident surface of the second prism sheet 13 faces the light emitting surface 122 of the first prism sheet 12. The light emitting surface of the second prism sheet 13 includes a number of second diffusion structures. In the embodiment, the second diffusion structures are formed to be a number of long-strip V-shaped ridge structures extending along at least two different directions and being mutually staggered.

In use, light beams emitted by the light sources 11 enter the first prism sheet 12. The incident light beams are refracted, scattered, reflected, or diffracted by the V-shaped ridge structures 123 of the first prism sheet 12, and are diffused into a number of virtual light sources gathering within a particular perspective.

Furthermore, the light beams exiting the first prism sheet 12 then enters the second prism sheet 13. The incident light beams are further refracted, scattered, reflected, or diffracted by the V-shaped ridge structures 123 of the first prism sheet 12, and are thus further diffused. As a result, the light beams exiting the transparent plate 14 become surface light beams, providing a good uniform optical performance, which avoids shadows and light spots.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A surface light source device comprising:
a housing comprising a bottom plate;
a plurality of light sources distributed on the bottom plate;
a first prism sheet arranged above the light sources; and
a second prism sheet arranged above the first prism sheet;
wherein, each of the first prism sheet and the second prism sheet comprises a light incident surface and a light emitting surface opposite to the light incident surface;
the light emitting surface of the first prism sheet comprises a plurality of first diffusion structures, and the light emitting surface of the second prism sheet comprises a plurality of second diffusion structures;
the light sources and the first prism sheets are spaced by a first predefined distance, and the first prism sheets and the second prism sheets are spaced by a second predefined distance; and
light beams emitted by the light sources are substantially diffused after passing through the first prism sheet and the second prism sheet and become surface light beams.

2. The surface light source device of claim 1, wherein each of the first diffusion structures and the second diffusion structures are in the form of a plurality of long-strip V-shaped ridge structures extending along different directions.

3. The surface light source device of claim 2, wherein the V-shaped ridge structures extend along four different directions.

4. The surface light source device of claim 3, wherein each three V-shaped ridge structures extending along different directions cooperatively define a micro-dent, each of which comprises three side surfaces connected in order.

5. The surface light source device of claim 4, wherein each four adjacent micro-dents cooperatively define a first micro-protrusion, and each eight adjacent micro-dents cooperatively define a second micro-protrusion.

6. The surface light source device of claim 1, further comprising a transparent plate arranged above the second prism sheet and covers the housing, wherein the transparent plate prevents the second prism sheet from being contaminated, or scratched.

7. The surface light source device of claim 6, wherein the transparent plate is made of transparent glass, frosted glass, or transparent plastic.

8. The surface light source device of claim 1, wherein the housing further comprises a plurality of sidewalls extending from a periphery of the bottom plate.

9. The surface light source device of claim 1, wherein the housing is made of metal or plastic material with high reflectivity rate.

10. The surface light source device of claim 1, wherein the housing has a high reflective coating applied on its internal sidewall for improving light reflectivity rate.
